(19) United States
(12) Patent Application Publication
(10) Pub. No.: US 2006/0255547 A1
(43) Pub. Date: Nov. 16, 2006

(54) Zip strip seal

(76) Inventor: Edward S. Widder, Antioch, IL (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/432,444

(22) Filed: May 11, 2006

Related U.S. Application Data
(60) Provisional application No. 60/680,166, filed on May 12, 2005.

(51) Int. Cl. F02F 11/00; F02B 77/00

(52) U.S. Cl. 277/592; 123/195 C

(57) ABSTRACT

The invention provides a seal assembly operable to form a seal between two housing parts. The seal assembly includes a deformable sealing member extending along a first enclosed path. The sealing member defines a channel cross-section perpendicular to the first enclosed path. The seal assembly also includes a strip member extending along a second enclosed path substantially similarly shaped as the first enclosed path. The strip member defines a strip cross-section perpendicular to the second enclosed path. The strip cross-section is substantially similarly shaped as the channel cross-section of the sealing member. The strip member is releasibly inserted in the channel cross-section to seal and substantially fix the two housing parts relative to one another.

This invention claims priority to U.S. Provisional Application Ser. No. 60/680,166, filed May 12, 2005.

### BACKGROUND OF THE INVENTION

1. Field of the Invention

The invention relates to a seal assembly and method for sealing two housing parts together, such as an engine block and an oil pan for example.

2. Related Prior Art

Many kinds of seals are known for forming a seal between two surfaces. A sealing member can be positioned between two surfaces that are urged toward one another so that the sealing member is compressed. The compressed seal member seals the surfaces relative to one another. Generally seals of this type fall into two main categories. Axial seals are generally compressed in the same direction as a direction of relative movement between the two surfaces. Transverse seals are generally compressed in a direction transverse to the direction of relative movement between the two surfaces.

### SUMMARY OF THE INVENTION

The invention provides a seal assembly operable to form a seal between two housing parts. The seal assembly includes a deformable sealing member extending along a first enclosed path. The sealing member defines a channel cross-section perpendicular to the first enclosed path. The seal assembly also includes a strip member extending along a second enclosed path substantially similarly shaped as the first enclosed path. The strip member defines a strip cross-section perpendicular to the second enclosed path. The strip cross-section is substantially similarly shaped as the channel cross-section of the sealing member. The strip member is releasibly inserted in the channel cross-section to seal and substantially fix the two housing parts relative to one another.

### BRIEF DESCRIPTION OF THE DRAWINGS

Features and advantages of the present invention will become more readily appreciated when considered in connection with the following detailed description and appended drawings, wherein:

FIG. 1 is an exploded view of a seal assembly according to the exemplary embodiment of the invention;

FIG. 2 is a cross-sectional view showing a first step of assembling the exemplary seal assembly between two housing parts;

FIG. 3 is a cross-sectional view showing a second step of assembling the exemplary seal assembly between the two housing parts; and

FIG. 4 is a cross-sectional view showing a third step of assembling the exemplary seal assembly between the two housing parts.

### DETAILED DESCRIPTION OF THE PREFERRED EMBODIMENT

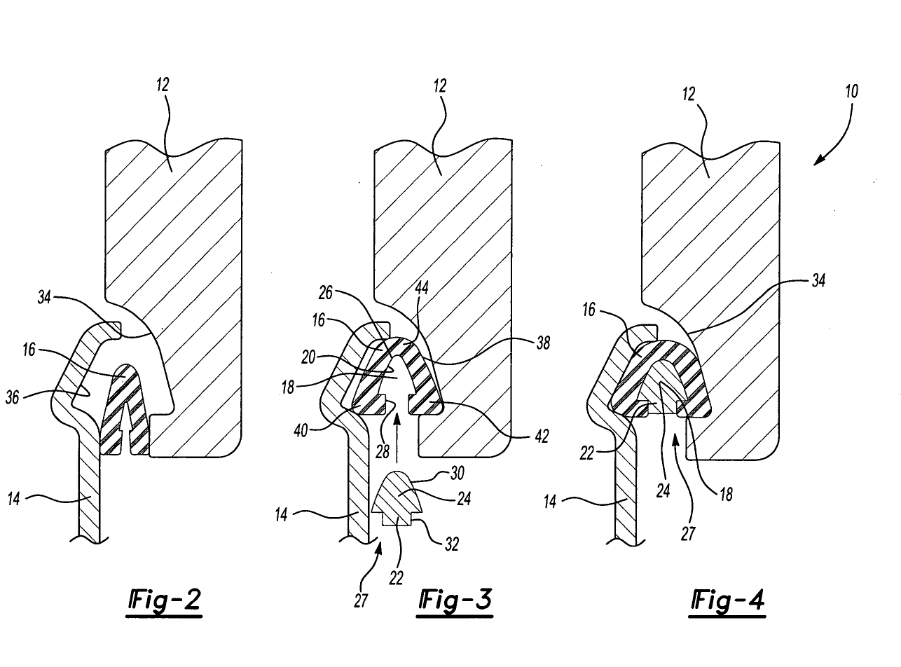

A seal assembly 10 is operable to form a seal between two housing parts 12, 14. In the exemplary embodiment of the invention, the housing part 12 is a skirt of a cylinder block of an engine. The housing part 14 of the exemplary embodiment of the invention is an oil pan. One of the housing parts 12, 14 could be a valve cover or another sealed enclosure in alternative embodiments of the invention. The housing parts 12, 14 overlap one another, as best shown in FIGS. 2-4.

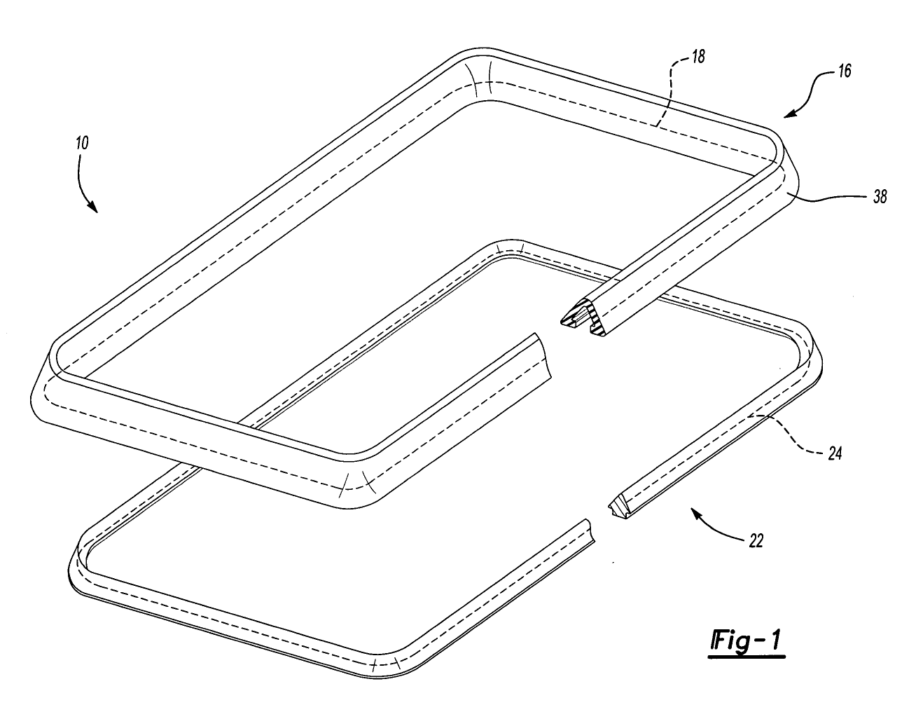

The seal assembly 10 includes a deformable sealing member 16 extending along a first enclosed path 18. The sealing member 16 extends along the first enclosed path 18 to form a loop-like structure. The structure can be rectangular, square, circular, elliptical or any other desired shape. The sealing member 16 defines a channel cross-section 20 perpendicular to the first enclosed path 18, shown unstressed in FIG. 3. FIG. 1 shows the sealing member 16 broken to show the cross-section perpendicular to the path 18 and, as a result, the path 18 does not appear to be enclosed but is enclosed. The sealing member 16 includes an outer surface 38 and is hastate in cross-section perpendicular to the path 18, having two lobes 40, 42 and a generally point portion 44. The channel cross-section 20 can be at least partially v-shaped. The exemplary channel cross-section 20 is arrow-shaped with a first head portion 26 and a first shaft portion 28.

The seal assembly 10 also includes a strip member 22 extending along a second enclosed path 24 substantially similarly shaped as the first enclosed path 18. The first and second paths 18, 24 are substantially parallel to one another. The strip member 22 defines a strip cross-section 27 perpendicular to the second enclosed path 24. FIG. 1 shows the strip member 22 broken to show the cross-section perpendicular to the path 24 and, as a result, the path 24 does not appear to be enclosed but is enclosed. The strip cross-section 27 is substantially similarly shaped as the channel cross-section 20 of the sealing member 16. The strip member 22 is releasibly inserted in the channel cross-section 20 to seal and substantially fix the two housing parts 12, 14 relative to one another. The strip cross-section 27 is wedge-shaped and the exemplary strip cross-section 27 is arrow-shaped with a second head portion 30 received in the first head portion 26 and a second shaft portion 32 received in the first shaft portion 28.

The two housing parts 12, 14 include first and second grooves 34, 36, respectively. The first and second grooves 34, 36 face one another and are spaced a distance apart. The grooves 34, 36 are disposed along the respective portions of the housing parts 12, 14 that overlap. The exemplary first and second grooves 34, 36 are substantially mirrored with respect to one another about the strip member 22 and cooperate to define a hastate cross-section.

In an exemplary operation, the sealing member 16 is moved to the first and second grooves 34, 36 after the housing parts 12, 14 have been overlapped with respect to one another, best shown in FIG. 2. The hastate body cross-section of the sealing member 16 is sized to be received in the hastate cross-section defined by the first and second grooves 34, 36. The sealing member 16 is compressed to be inserted in the grooves 34, 36, best shown in FIG. 2, and springs back after insertion, best shown in FIG. 3. After the sealing member 16 has been received in the grooves 34, 36, the strip member 22 is releasibly inserted in the channel cross-section 20. The sealing member 16 is deformably compressed between the strip member 22 and the first groove 34 as well as between the strip member 22 and the second groove 36. The strip member 22 is not integral with the first and second grooves 34, 36 and is spaced from both the first and second grooves 34, 36. The strip member 22 can define one or more threaded apertures to assist moving the strip member 22 into the channel cross-section 20. The sealing member 16 and the strip member 22 of the exemplary embodiment of the invention can withstand the operating conditions of an engine, such as oil exposure and relatively high temperatures.

When strip member 22 is releasibly inserted in the channel cross-section 20, the housing parts 12, 14 are sealed relative to one another and are also, substantially fixed relative to one another. The seal assembly 10 acts as a zip strip seal utilizing a side loaded joint configuration that does not required fasteners for generating load on the sealing member 16. Also, the cooperation between the housing parts 12, 14, the sealing member 16 and the strip member 22 vibrationally isolates the housing parts 12, 14 from one another.

Obviously, many modifications and variations of the present invention are possible in light of the above teachings. It is, therefore, to be understood that within the scope of the appended claims, the invention may be practiced otherwise than as specifically described.

What is claimed is:

1. A seal assembly operable to form a seal between two housing parts comprising:
a deformable sealing member extending along a first enclosed path and defining a channel cross-section perpendicular to said first enclosed path; and
a strip member extending along a second enclosed path substantially similarly shaped as said first enclosed path and defining a strip cross-section perpendicular to said second enclosed path and substantially similarly shaped as said channel cross-section of said sealing member wherein said strip member is releasibly inserted in said channel cross-section to seal and substantially fix the two housing parts relative to one another.

2. The seal assembly of claim 1 wherein said sealing member is operable to be positioned between the two housing parts before said strip member is releasibly inserted in said channel cross-section.

3. The seal assembly of claim 1 wherein said channel cross-section is at least partially v-shaped and said strip cross-section is wedge-shaped.

4. The seal assembly of claim 1 wherein said channel cross-section is arrow-shaped with a first head portion and a first shaft portion and said strip cross-section is arrow-shaped with a second head portion received in said first head portion and a second shaft portion received in said first shaft portion.

5. The seal assembly of claim 1 further comprising:
first and second grooves individually defined by the two housing parts and facing one another spaced a distance apart wherein said sealing member being deformably compressed between said strip member and said first groove and being deformably compressed between said strip member and said second groove and wherein said strip member is spaced from said first and second grooves.

6. The seal assembly of claim 5 wherein said first and second grooves are substantially mirrored with respect to one another about said strip member.

7. The seal assembly of claim 6 wherein said first and second grooves cooperate to define a hastate cross-section.

8. The seal assembly of claim 7 wherein a body cross-section of said sealing member perpendicular to said first enclosed path is hastate and sized to be received in said hastate cross-section defined by said first and second grooves

9. The seal assembly of claim 8 wherein said channel cross-section is arrow-shaped with a first head portion and a first shaft portion and said strip cross-section is arrow-shaped with a second head portion received in said first head portion and a second shaft portion received in said first shaft portion.

10. A method to form a seal between two housing parts comprising:
defining a channel cross-section with a deformable sealing member extending along a first enclosed path and wherein the channel cross-section is perpendicular to the first enclosed path; and
extending a strip member along a second enclosed path substantially similarly shaped as the first enclosed path and defining a strip cross-section perpendicular to the second enclosed path and substantially similarly shaped as the channel cross-section of the sealing member; and
releasibly inserting the strip member in the channel cross-section to seal and substantially fix the two housing parts relative to one another.

11. The method of claim 11 further comprising the step of:
aligning first and second grooves individually defined by the two housing parts to face one another a spaced distance apart prior to said releasibly inserting step.

12. The method of claim 11 further comprising the step of:
releasibly inserting the deformable sealing member between the first and second grooves prior to said step of releasibly inserting step the strip member.

13. The method of claim 12 wherein said step of releasibly inserting the deformable sealing member is subsequent to said aligning step.

14. The method of claim 13 wherein said step of releasibly inserting the strip member is further defined as:
compressing the sealing member perpendicular to the first enclosed path between the strip member and the first groove and as well as between the strip member and the second groove.
